(19) United States
(12) Patent Application Publication
(10) Pub. No.: US 2006/0210707 A1
(43) Pub. Date: Sep. 21, 2006

(54) METHOD FOR MANUFACTURING COLOR FILTERS

(76) Inventor: Ga-Lane Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,210

(22) Filed: Jan. 26, 2006

(30) Foreign Application Priority Data
Mar. 18, 2005 (TW) 094108452

(51) Int. Cl. G02B 5/20

(52) U.S. Cl. 427/162; 427/264; 427/277; 427/278

(57) ABSTRACT

A method for manufacturing a color filter includes the following steps: (a) forming a black matrix layer (240) on a substrate (210) by means of imprinting; (b) using a multi-head ink-jet array (MHIJA) (300) to color the black matrix layer, thereby forming a color layer (250) thereon; and (c) forming an indium-tin oxide (ITO) layer (260) on the color layer. The means of imprinting can form the black matrix layer quickly. This enhances a manufacturing efficiency and decreases a manufacturing cost. Furthermore, the multi-head ink-jet array can color the black matrix layer by jetting inks once. This enhances a manufacturing efficiency, saves the ink and decreases a manufacturing cost. Therefore, the method has an enhanced efficiency and a decreased cost.

### DESCRIPTION

1. Field of the Invention

The invention relates generally to methods for manufacturing color filters; and more particularly, to a method for manufacturing a color filter, the method having an enhanced efficiency and a reduced cost.

2. Description of Related Art

Color filters are generally used in liquid crystal display devices for converting white light beams transmitted therethrough into red light beams, green light beams and blue light beams. The red light beams, green light beams and blue light beams are configured for the liquid crystal display devices displaying color images.

A typical color filter generally includes a substrate, a black matrix layer, a color layer, and an indium-tin oxide (ITO) layer. The black matrix layer is formed on the substrate and is used to separate sub-pixels of the color layer from each other. The color layer is formed on the black matrix layer and includes the red, green and blue sub-pixels. The indium-tin oxide (ITO) layer is formed on the color layer. The color filter is one of the most important components in the liquid crystal display device. The cost of the color filter is about 28% of a total cost of the liquid crystal display device. That is, the cost of the liquid crystal display device is mainly determined by the manufacturing cost of the color filter. Thus, the manufacturing cost of the color filter is required to be as low as possible in order to reduce the cost of the liquid crystal display device.

Conventional methods for manufacturing the color filter includes a dyeing method, a pigment dispersed method, a printing method and an electrodeposition method. The above-mentioned methods generally need forming the black matrix layer by means of a lithography process. The lithography process is relatively time-consuming and complicated. Thus, the manufacturing cost of the black matrix by the conventional methods is relatively high.

The dyeing method adopts dyes to form the color layer. Red dye, green dye and blue dye are dyed on the black matrix layer respectively to form the red, green and blue sub-pixels. That is, the dyeing process has to be repeated three times. The dyes have the following advantages: multiple kinds, uniform chroma, high saturation, and high light permeance. However, the dyes have poor light resistance and heat resistance. Furthermore, a cost of the dyes and the manufacturing devices is relatively high, and a manufacturing process is relatively time-consuming. Thus, the dyeing method has a relatively high cost and is unsatisfactory.

The pigment dispersed method adopts pigments to form the color layer by means of an etching process or a lithography imaging process. Red pigment, green pigment and blue pigment are dispersed on the black matrix layer respectively to form the red, green and blue sub-pixels. That is, the etching or lithography imaging process has to be repeated three times. The pigments has good light resistance and heat resistance. However, a smoothness and uniformity of the pigments on the black matrix layer can't be readily controlled. Furthermore, the cost of the manufacturing devices is relatively high and the manufacturing process is relatively long. Thus, the pigment dispersed method has a relatively high cost and is unsatisfactory.

The printing method is to print ink onto the black matrix. The printing method may be such as a screen printing method, an offset printing method, a gravure printing method and a relief printing method. Red ink, green ink and blue ink are printed on the black matrix layer respectively to form the red, green and blue sub-pixels. That is, the printing process has to be repeated three times. The cost of the inks and the manufacturing devices is relatively low. However, a smoothness and uniformity of the inks on the black matrix layer can't be readily controlled. Furthermore, the manufacturing process is relatively time-consuming. Thus, the printing method is unsatisfactory.

The electrodeposition method uses electrophoretic technique to deposit pigment on the black matrix layer. Red pigment, green pigment and blue pigment are deposited on the black matrix layer respectively to form the red, green and blue sub-pixels. That is, the depositing process has to be repeated three times. A smoothness and uniformity of the pigments on the black matrix layer is good. However, the cost of the manufacturing devices is relatively high. Furthermore, a manufacturing process is relatively time-consuming and complicated. Thus, the electrodeposition method has a relatively high cost and is unsatisfactory.

What is needed, therefore, is a method for manufacturing a color filter, the method having an enhanced efficiency and a decreased cost.

### SUMMARY OF INVENTION

In one embodiment, a method for manufacturing a color filter includes the following steps: (a) forming a black matrix layer on a substrate by means of imprinting; (b) using a multi-head ink-jet array (MHIJA) to color the black matrix layer, thereby forming a color layer thereon; and (c) forming an indium-tin oxide (ITO) layer on the color layer.

The means of imprinting can form the black matrix layer quickly. This enhances a manufacturing efficiency and decreases a manufacturing cost thereof. Furthermore, the multi-head ink-jet array can color the black matrix layer by jetting ink once. This enhances a manufacturing efficiency, saves the ink and decreases a manufacturing cost. Therefore, the method has an enhanced efficiency and a decreased cost.

Other advantages and novel features of the present method will become more apparent from the following detailed description of preferred embodiments when taken in conjunction with the accompanying drawings.

### BRIEF DESCRIPTION OF DRAWINGS

Many aspects of the present method can be better understood with reference to the following drawings. The components in the drawings are not necessarily to scale, the emphasis instead being placed upon clearly illustrating the principles of the present method.

FIGS. 1a-1d are schematic, side views, showing successive stages of a process of manufacturing a black matrix layer of a color filter, in accordance with a preferred embodiment of the present method;

FIG. 2 is a schematic, top view of the black matrix layer made by the process shown in FIGS. 1a-1d;

FIG. 3 is a schematic, side view, showing a process of manufacturing the black matrix layer according to an alternative embodiment;

FIG. 4 is a schematic, side view, showing a process of the black matrix layer according to another alternatively manufacturing;

FIG. 5 is a schematic, side view of a multi-head ink-jet array (MHIJA) adopted in the present method, the MHIJA being used to jet inks onto the black matrix layer of FIG. 2;

FIG. 6 is a schematic, top view of the black matrix layer with a color layer formed thereon; and

FIG. 7 is a schematic, side view of FIG. 6, showing an indium-tin oxide (ITO) layer formed on the color layer (i.e., the color filter);

Corresponding reference characters indicate corresponding parts throughout the several views. The exemplifications set out herein illustrate at least one preferred embodiment of the present method, in one form, and such exemplifications are not to be construed as limiting the scope of the invention in any manner.

### DETAILED DESCRIPTION

Reference will now be made to the drawings to describe embodiments of the present method.

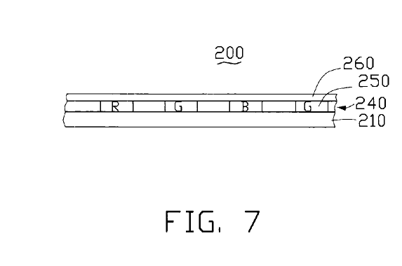

Referring to FIG. 7, the present method for manufacturing a color filter 200 comprises the steps of: (a) forming a black matrix layer 240 on a substrate 210 by means of imprinting; (b) coloring the black matrix layer 240 to form a color layer 250 thereon; and (c) forming an indium-tin oxide (ITO) layer 260 on the color layer 250.

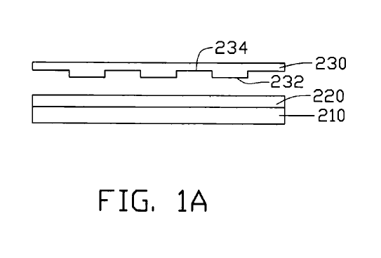

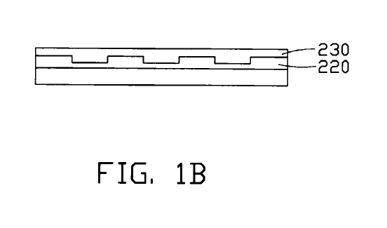

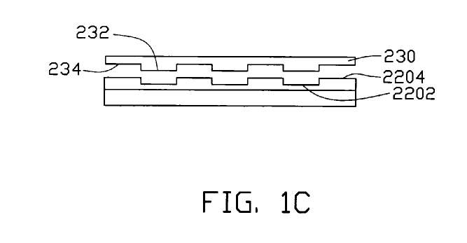

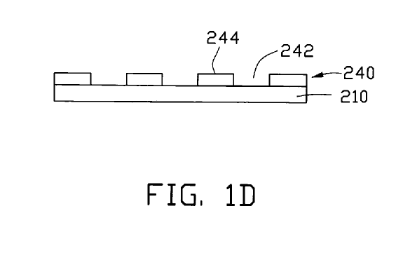

The step (a) can be performed by means of nano-imprinting or hot embossing. Referring to FIGS. 1a-1d, the step (a) includes the steps of: (a1) disposing a photoresist film 220 on the substrate 210; (a2) using an imprinting stamper 230 having certain patterns (i.e., protrusions 232 and recesses 234) associated therewith to imprint the photoresist film 220, thereby the photoresist film 220 having certain patterns (i.e., recesses 2202 and protrusions 2204) directly associated with the certain patterns of the imprinting stamper 230; and (a3) removing the imprinting stamper 230 and etching the residual photoresist portion corresponding to the patterns of recesses 2202 on the photoresist film 220.

The substrate 210 in step (a1) is comprised of one of glass, plastic (i.e., polymethylmethacrylate (PMMA) or polycarbonate) and other transparent material. In step (a1), the substrate 210 is firstly cleaned. Then, the photoresist film 220 is disposed on the substrate 210 by means of spin-coating, uniform coating, pre-coating or chemical vapor deposition (CVD) (shown in FIG. 1(a)).

The imprinting stamper 230 in step (a2) is made of a nickel phosphorus alloy (i.e., NiP). The proportion by mass of the phosphorus to the alloy is about in the range from 5% to 15%. A thickness of the nickel is about in the range from 500 micrometers to 2 millimeters. Because the nickel phosphorus alloy has good fracture toughness, the imprinting stamper 230 can withstand higher pressure and is more durable. The imprinting stamper 230 can be made by means of lithography electroforming micro molding (LIGA) (i.e., LIGA is an abbreviation of a German phrase “Lithographie Galvanoformung Abformung”, and an English translation of that phrase is “lithography electroforming micro molding”), electron-beam lithography, X-ray lithography or ion-beam lithography. As shown in FIG. 1(a), the imprinting stamper 230 has no pinholes and defects. The imprinting stamper 230 is flat and has the protrusions 232 and recesses 234 formed on a surface thereof (i.e., a patterned surface).

Referring particularly to FIG. 1b, the step (a2) is executed as follows. Firstly, the imprinting stamper 230 and the photoresist film 220 are heated to a temperature of about 200° C., which is higher than the glass transition temperature (about 105° C.) of the PMMA. Then, the imprinting stamper 230 (specifically the patterned surface thereof) is compressed against the photoresist film 220 evenly and is held there until the temperature drops below the PMMA's glass transition temperature. The optimum pressure is about 1900 psi. Thus, the patterns of the imprinting stamper 230 are almost fully, if not totally, transferred into the photoresist film 220, thereby forming the photoresist film 220 having certain patterns (i.e., protrusions 2204 and recesses 2202) corresponding to the certain patterns (i.e., recesses 234 and protrusions 232) associated with the imprinting stamper 230 (as shown in FIG. 1c). It is to be understood that the imprinting stamper 230, in all the various embodiments, operates as a mold in that a face or surface thereof provides a “negative image” of the surface it is used to form. In this case, the patterns formed on the photoresist film 220 are mirroring those of the imprinting stamper 230. That is, the protrusions 2204 of the photoresist film 220 is corresponding to the recesses 234 of the imprinting stamper 230, and the recesses 2202 of the photoresist film 220 is corresponding to the protrusion 232 of the imprinting stamper 230. Also, while the imprinting stamper 230 is disclosed to be used as a part of a hot embossing procedure, it is to be understood that any molding process incorporating the present imprinting stamper 230 and resulting in the desired patterns on a photoresist film is considered to be within the scope of the present method.

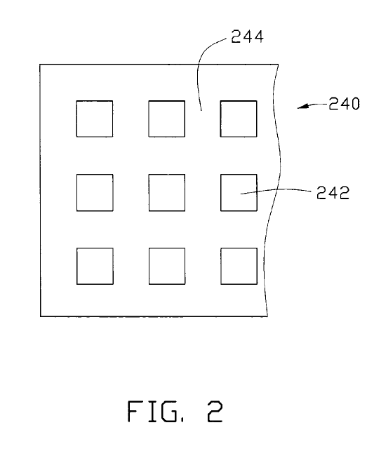

Then, as shown in FIG. 1d, the imprinting stamper 230 is removed. In step (a3), the residual photoresist portion corresponding to the recesses 2202 on the photoresist film 220 is etched by means of reactive ion etching (RIE). Therefore, as shown in FIG. 1d and FIG. 2, the black matrix layer 240 is formed on the substrate 210. The black matrix layer 240 has a plurality of sub-pixels 242 and partition lines 244. The partition lines 244 are used to separate the sub-pixels 242 from each other.

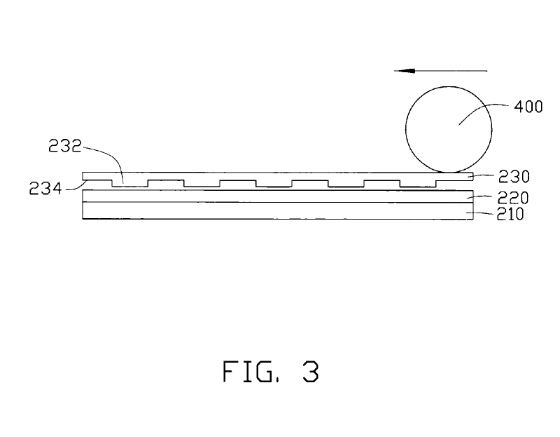

Alternatively, as shown in FIG. 3, the step (a2) could be executed as follows. Firstly, a wheel 400 is disposed on the imprinting stamper 230. Then, the wheel 400 is rolled through the imprinting stamper 230. Thus, the patterns of the imprinting stamper 230 are almost fully, if not totally, transferred into the photoresist film 220, thereby forming the photoresist film 220 having certain patterns mirroring those of the imprinting stamper 230.

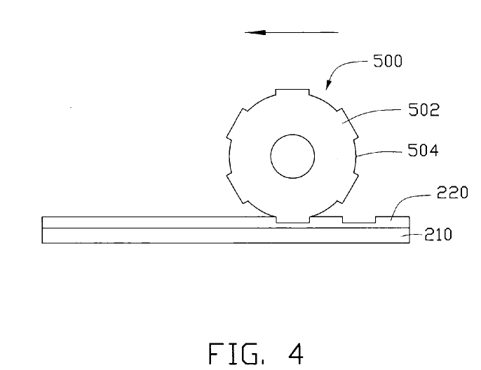

Further alternatively, as shown in FIG. 4, an imprinting stamper 500 adopted could be a sawtooth wheel. The sawtooth-wheel stamper 500 has a plurality of protrusion 502 and recesses 504. Correspondingly, the step (a2) is executed as follows. The sawtooth-wheel stamper 500 is rolled through the photoresist film 220. Thus, the patterns of the sawtooth-wheel stamper 500 are almost fully, if not totally, transferred into the photoresist film 220, thereby forming the photoresist film 220 having certain patterns mirroring those of the imprinting stamper 230.

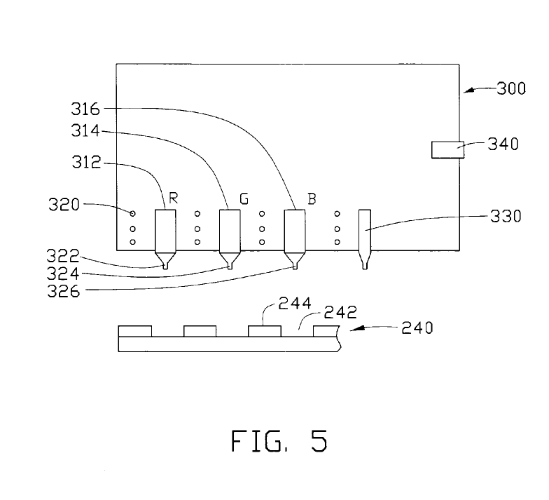

In step (b), a multi-head ink-jet array (MHIJA) 300 is adopted to color the black matrix layer 240. Referring to FIG. 5, the MHIJA 300 includes a plurality of ink boxes 312, 314, 316, a heater coil 320, a charge coupled device (CCD) 330 and a micro-controller 340. The first ink box 312 has red ink therein and a first nozzle 322 positioned at a free end thereof. The second ink box 314 has green ink therein and a second nozzle 324 positioned at a free end thereof. The third ink box 316 has blue ink therein and a third nozzle 326 positioned at a free end thereof. The heater coil 320 surrounds the ink boxes 312, 314, 316. The heater coil 320 is used to control thermal bubble formations of ink. The charge coupled device (CCD) 330 has a high resolution and is used to ensure a high resolution image of each sub-pixel 242 and partition lines 244 of the black matrix layer 240. The micro-controller 340 is used to move the MHIJA 300 to desired locations corresponding to the desired sub-pixels 242. A movement controllable accuracy is in the range from −0.5 micrometers to +0.5 micrometers.

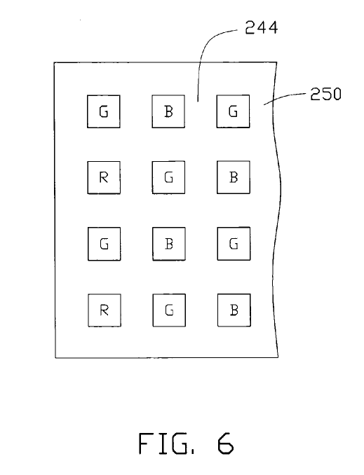

During the coloring process, the micro-controller 340 move the MHIJA 300 to desired locations corresponding to the desired sub-pixels 242. The heater coil 320 is electrified. This ensures that some of the red ink in the first ink box 312 forms red thermal bubbles, some of the green ink in the second ink box 314 forms green thermal bubbles, and some of the blue ink in the third ink box 316 forms blue thermal bubbles. The red thermal bubbles inflate quickly, and push the red ink to jet from the first nozzle 322 and drop on the corresponding sub-pixel 242. The green thermal bubbles inflate quickly, and push the green ink to jet from the second nozzle 324 and drop on the corresponding sub-pixel 242. The blue thermal bubbles inflate quickly, and push the blue ink to jet from the third nozzle 326 and drop on the corresponding sub-pixel 242. Therefore, a color layer 250 is formed on the black matrix layer 240. As shown in FIG. 6, the color layer 250 includes three kinds of colors (i.e., red, green and blue). The colored sub-pixels 242 are insulated from each other by the partition lines 244.

Then, the color layer 250 is dried. After that, the indium-tin oxide (ITO) layer 260 is formed on the color layer 250 by means of sputtering, spin-coating or chemical vapor deposition (CVD).

In use, a white light is transmitted to the color filter 200, and is transmitted through the transparent substrate 210. Then, the red sub-pixels 242 allow the red light beams of the white light to pass therethrough, the green sub-pixels 242 allow the green light beams of the white light to pass therethrough and the blue sub-pixels 242 allow the blue light beams of the white light to pass therethrough. After that, the separated red light beams, green light beams and blue light beams are transmitted through the transparent indium-tin oxide (ITO) layer 260.

Compared with a conventional manufacturing method, the present method adopts the imprinting technology to form the black matrix layer 240. The imprinting process can be completed quickly and easily. This enhances a manufacturing efficiency and decreases a manufacturing cost. Furthermore, the present method adopts the multi-head ink-jet array 300 to color the black matrix layer 240 by jetting inks once. This enhances a manufacturing efficiency, saves the ink and decreases a manufacturing cost. Therefore, the present method has an enhanced efficiency and a decreased cost.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A method for manufacturing a color filter, comprising the steps of:
(a) forming a black matrix layer on a substrate by means of imprinting, the black matrix layer comprising a plurality of sub-pixels and partition lines separating the sub-pixels from each other;
(b) coloring the black matrix layer to form a color layer thereon; and
(c) forming an indium-tin oxide (ITO) layer on the color layer.

2. The method as claimed in claim 1, wherein step (a) is performed by means of nano-imprinting.

3. The method as claimed in claim 1, wherein step (a) is performed by means of hot embossing.

4. The method as claimed in claim 1, wherein step (a) comprises the steps of:
(a1) disposing a photoresist film on a substrate;
(a2) using an imprinting stamper having certain patterns associated therewith to imprint the photoresist film, thereby the photoresist film having certain patterns directly associated with the certain patterns of the imprinting stamper; and
(a3) removing the imprinting stamper and etching the residual photoresist portion corresponding to the patterns of recesses on the photoresist film.

5. The method as claimed in claim 4, wherein the substrate in step (a1) is comprised of one of glass and plastic.

6. The method as claimed in claim 5, wherein the plastic is comprised of one of polymethylmethacrylate (PMMA) and polycarbonate.

7. The method as claimed in claim 4, wherein in step (a1), the photoresist film is disposed on the substrate by means of one of spin-coating, uniform coating, pre-coating and chemical vapor deposition (CVD).

8. The method as claimed in claim 4, wherein the imprinting stamper in step (a2) is made of a nickel phosphorus alloy, and the proportion by mass of the phosphorus to the alloy is about in the range from 5% to 15%.

9. The method as claimed in claim 4, wherein the imprinting stamper in step (a2) is made by means of a method selected from the group consisting of lithography electroforming micro molding (LIGA), electron-beam lithography, X-ray lithography and ion-beam lithography.

10. The method as claimed in claim 4, wherein the imprinting stamper in step (a2) is flat.

11. The method as claimed in claim 10, wherein the imprinting process is performed by compressing the imprinting stamper against the photoresist film evenly.

12. The method as claimed in claim 10, wherein the imprinting process is performed by disposing a wheel on the imprinting stamper and rolling the wheel through the imprinting stamper which is disposed on the photoresist film.

13. The method as claimed in claim 4, wherein the imprinting stamper in step (a2) is a sawtooth wheel.

14. The method as claimed in claim 13, wherein the imprinting process is performed by rolling the sawtooth wheel through the photoresist film.

15. The method as claimed in claim 4, wherein the etching process in step (a3) is performed by means of reactive ion etching (RIE).

16. The method as claimed in claim 1, wherein in step (b), the coloring process is performed using a multi-head ink-jet array (MHIJA), the MHIJA comprising:
at least three ink boxes, the ink boxes having red ink, green ink and blue ink therein respectively;
at least a heater coil disposed surrounding the ink boxes;
at least a charge coupled device (CCD) for ensuring a high resolution image of each sub-pixel and partition lines of the black matrix layer; and
at least a micro-controller for moving the MHIJA to desired locations corresponding to the desired sub-pixels.

17. The method as claimed in claim 16, wherein each ink box has a nozzle formed at a free end thereof.

18. The method as claimed in claim 16, wherein a movement controllable accuracy is in the range from −0.5 micrometers to +0.5 micrometers.

19. The method as claimed in claim 1, wherein in step (c), the indium-tin oxide (ITO) layer is formed on the color layer by means of a method selected from the group consisting of sputtering, spin-coating and chemical vapor deposition (CVD).
